(19) United States
(12) Patent Application Publication
(10) Pub. No.: US 2023/0058508 A1
(43) Pub. Date: Feb. 23, 2023

(54) SYSTEM AMD METHOD FOR PROVIDING SITUATIONAL AWARENESS INTERFACES FOR A VEHICLE OCCUPANT

(71) Applicant: GM GLOBAL TECHNOLOGY OPERATIONS LLC, Detroit, MI (US)

(72) Inventors: Lawrence A. Bush, Shelby Township, MI (US); Joseph F. Szczerba, Grand Blanc, MI (US); Roy J. Mathieu, Rochester Hills, MI (US)

(73) Assignee: GM GLOBAL TECHNOLOGY OPERATIONS LLC, Detroit, MI (US)

(21) Appl. No.: 17/445,450

(22) Filed: Aug. 19, 2021

(51) Int. Cl. G01C 21/36; B60W 50/16; B60W 60/00; B60W 40/105

(52) U.S. Cl. CPC G01C 21/3641; G01C 21/3676; G01C 21/3632; G01C 21/3697; B60W 50/16; B60W 60/0015; B60W 60/005; B60W 40/105; B60W 2050/146

(57) ABSTRACT

A method for providing a situational awareness interface for an occupant of an automated vehicle is provided. The method includes: generating a vehicle route graphic that displays a street level map of an area that includes a current location of the vehicle and an intended destination of the vehicle along with a visual depiction of a planned route and one or more alternate routes for the vehicle; determining a probability of requiring assistance or interaction and an estimated time of arrival for each of the planned route and the one or more alternate routes; providing a visual indication of the probability of requiring assistance or interaction and the estimated time of arrival for each of the planned route and the one or more alternate routes on the vehicle route graphic; and signaling a display device to display the vehicle route graphic.

### TECHNICAL FIELD

The technology described in this patent document relates generally to situational awareness interfaces and more particularly to providing a situational awareness interface for use by an occupant when riding in a fully autonomous or semi-autonomous vehicle.

Passengers in an automated vehicle may need information to build trust in automation, understand and select routing options, identify risks, prepare for vehicle intent of maneuvers, and a means to procure assistance when necessary.

Accordingly, it is desirable to provide a situational awareness interface for an occupant to use when riding in an autonomous or semiautonomous vehicle. Furthermore, other desirable features and characteristics will become apparent from the subsequent detailed description and the appended claims, taken in conjunction with the accompanying drawings.

### SUMMARY

Systems and methods for providing a situational awareness interface are provided. In one embodiment, a supervisory control system for providing a situational awareness interface for an occupant of an automated vehicle is disclosed. The system includes a controller configured to: generate a bird's eye view graphic that provides an indication of vehicle maneuver intent; generate a vehicle route graphic that displays a street level map of an area that includes a current location of the vehicle and an intended destination of the vehicle along with a visual depiction of a planned route and one or more alternate routes for the vehicle from the current location of the vehicle to the intended destination; determine a probability of requiring assistance or interaction and an estimated time of arrival for each of the planned route and the one or more alternate routes; provide a visual indication of the probability of requiring assistance or interaction and the estimated time of arrival for each of the planned route and the one or more alternate routes on the vehicle route graphic; configure the visual depiction of the planned route and the one or more alternate routes to be selectable, wherein when a route is selected, the controller instructs the vehicle to navigate in accordance with the selected route; and signal a display device to display the situational awareness interface which includes the bird's eye view graphic and the vehicle route graphic.

In one embodiment, to generate a bird's eye view graphic that provides an indication of vehicle maneuver intent, the controller is configured to generate a bird's eye view graphic that provides an elevated view of a roadway surrounding the vehicle; overlay a direction of travel graphic on the bird's eye view graphic centered at a location consistent with retrieved location data wherein the direction of travel graphic has a predetermined length and width centered around the location; position, based on the location data, a vehicle icon that is representative of the vehicle on the bird's eye view graphic overlaying the direction of travel graphic; retrieve potential obstacle location data for each potential obstacle identified within a predetermined distance surrounding the vehicle; and for each identified potential obstacle, position an obstacle icon representative of the potential obstacle on the bird's eye view graphic.

In one embodiment, the controller is further configured to: identify a readiness state for a plurality of vehicle systems for autonomous travel; generate a ready-state graphic that provides a visual indication of the readiness state for the plurality of vehicle systems; and signal the display device to display the ready-state graphic.

In one embodiment, the controller is further configured to: generate an occupant control interface that includes an assistance interface (e.g., SOS button) for enabling the occupant to stop the vehicle or summon help, and provide the occupant control interface in the situational awareness interface.

In one embodiment, the controller is further configured to provide an in-vehicle security and emergency services system (e.g., OnStar) interface in the occupant control interface for enabling the occupant to access a remote operator for an in-vehicle security and emergency services system.

In one embodiment, the controller is further configured to signal the display device to display an informational graphic informing that a remote operator will take control of the vehicle as part of the situational awareness interface.

In one embodiment, the controller is further configured to determine a route from the current location of the vehicle to the intended destination that reduces a likelihood of needing operator intervention, and provide the route that reduces the likelihood of needing operator intervention as the planned route for the vehicle or the one or more alternate routes for the vehicle.

In one embodiment, the controller is further configured to identify a state of an upcoming traffic control device (e.g., traffic light, stop sign, yield sign) in a direction of vehicle travel from on-board vehicle input sensor data or off board input sensor data, generate a traffic control device icon representative of the upcoming traffic control device that indicates the state of the upcoming traffic control device, and overlay the traffic control device icon on the bird's eye view graphic.

In one embodiment, the controller is further configured to identify a speed limit in a direction of vehicle travel from on-board vehicle input sensor data or off board input sensor data, generate a speed limit icon that indicates the speed limit in the direction of vehicle travel, and overlay the speed limit icon on the bird's eye view graphic.

In one embodiment, the controller is further configured to identify a direction of vehicle travel from on-board vehicle input sensor data or off board input sensor data, generate a vehicle travel direction icon (e.g., arrow) that indicates the direction of vehicle travel, and overlay the vehicle travel direction icon on the bird's eye view graphic (e.g., on the direction of travel graphic).

In one embodiment, the controller is further configured to retrieve LIDAR data from on-board vehicle input sensor data, generate a LIDAR map graphic that indicates objects sensed via the LIDAR data, and overlay the LIDAR map graphic on the bird's eye view graphic.

In one embodiment, the controller is further configured to retrieve vehicle speed data that indicates current vehicle speed from on-board vehicle input sensor data, generate a vehicle speed graphic that indicates the current vehicle speed, and overlay the vehicle speed graphic on the bird's eye view graphic.

In one embodiment, the controller is further configured to generate a vehicle acceleration graphic that indicates whether the vehicle is accelerating, and overlay the vehicle acceleration graphic on the bird's eye view graphic.

In one embodiment, the controller is further configured to assess whether vehicle travel into an area represented by an area of the direction of travel graphic could result in unsafe vehicle operation (e.g., driving off the road, collision with an obstacle), and apply a specific color to the area of the direction of travel graphic when vehicle travel into the area represented by the area of the direction of travel graphic could result in unsafe vehicle operation.

In one embodiment, the controller is further configured to control a plurality of haptic actuators to provide haptic feedback to convey a sense of direction to an occupant seated in a seating apparatus while riding in the vehicle.

In one embodiment, the controller is further configured to control a plurality of speakers in a directional speaker system in a vehicle to convey a sense of direction to an occupant seated in a seating apparatus while riding in the vehicle.

In another embodiment, a supervisory control system for providing a situational awareness interface for an occupant of an automated vehicle is provided. The system includes a controller configured to: generate a vehicle route graphic that displays a street level map of an area that includes a current location of the vehicle and an intended destination of the vehicle along with a visual depiction of a planned route and one or more alternate routes for the vehicle from the current location of the vehicle to the intended destination; determine a probability of requiring assistance or interaction and an estimated time of arrival for each of the planned route and the one or more alternate routes; provide a visual indication of the probability of requiring assistance or interaction and the estimated time of arrival for each of the planned route and the one or more alternate routes on the vehicle route graphic; configure the visual depiction of the planned route and the one or more alternate routes to be selectable, wherein when a route is selected, the controller instructs the vehicle to navigate in accordance with the selected route; and signal a display device to display the situational awareness interface which includes the vehicle route graphic.

In one embodiment, the controller is further configured to determine a route from the current location of the vehicle to the intended destination that reduces a likelihood of needing operator intervention, and provide the route that reduces the likelihood of needing operator intervention as the planned route for the vehicle or the one or more alternate routes for the vehicle.

In another embodiment, a method for providing a situational awareness interface for an occupant of an automated vehicle is provided. The method includes: generating a bird's eye view graphic that provides an indication of vehicle maneuver intent; generating a vehicle route graphic that displays a street level map of an area that includes a current location of the vehicle and an intended destination of the vehicle along with a visual depiction of a planned route and one or more alternate routes for the vehicle from the current location of the vehicle to the intended destination; determining a probability of requiring assistance or interaction and an estimated time of arrival for each of the planned route and the one or more alternate routes; providing a visual indication of the probability of requiring assistance or interaction and the estimated time of arrival for each of the planned route and the one or more alternate routes on the vehicle route graphic; configuring the visual depiction of the planned route and the one or more alternate routes to be selectable, wherein when a route is selected, the vehicle is instructed to navigate in accordance with the selected route; and signaling a display device to display the situational awareness interface which includes the bird's eye view graphic and the vehicle route graphic.

In one embodiment, generating a bird's eye view graphic that provides an indication of vehicle maneuver intent includes generating a bird's eye view graphic that provides an elevated view of a roadway surrounding the vehicle; overlaying a direction of travel graphic on the bird's eye view graphic centered at a location consistent with retrieved location data wherein the direction of travel graphic has a predetermined length and width centered around the location; positioning, based on the location data, a vehicle icon that is representative of the vehicle on the bird's eye view graphic overlaying the direction of travel graphic; retrieving potential obstacle location data for each potential obstacle identified within a predetermined distance surrounding the vehicle; and positioning an obstacle icon representative of the potential obstacle on the bird's eye view graphic for each identified potential obstacle.

In one embodiment, the method further includes identifying a readiness state for a plurality of vehicle systems for autonomous travel, generating a ready-state graphic that provides a visual indication of the readiness state for the plurality of vehicle systems, and signaling the display device to display the ready-state graphic.

In one embodiment, the method further includes generating an occupant control interface that includes an assistance interface (e.g., SOS button) for enabling the occupant to stop the vehicle or summon help, and providing the occupant control interface in the situational awareness interface.

In one embodiment, the method further includes providing an in-vehicle security and emergency services system (e.g., OnStar) interface in the occupant control interface for enabling the occupant to access a remote operator for an in-vehicle security and emergency services system.

In one embodiment, the method further includes signaling the display device to display an informational graphic informing that a remote operator will take control of the vehicle.

In one embodiment, the method further includes determining a route from the current location of the vehicle to the intended destination that reduces a likelihood of needing operator intervention, and providing the route that reduces the likelihood of needing operator intervention as the planned route for the vehicle or the one or more alternate routes for the vehicle.

In one embodiment, the method further includes identifying a state of an upcoming traffic control device (e.g., traffic light, stop sign, yield sign) in a direction of vehicle travel from on-board vehicle input sensor data or off board input sensor data, generating a traffic control device icon representative of the upcoming traffic control device that indicates the state of the upcoming traffic control device, and overlaying the traffic control device icon on the bird's eye view graphic.

In one embodiment, the method further includes identifying a speed limit in a direction of vehicle travel from on-board vehicle input sensor data or off board input sensor data; generating a speed limit icon that indicates the speed limit in the direction of vehicle travel; and overlaying the speed limit icon on the bird's eye view graphic.

In one embodiment, the method further includes identifying a direction of vehicle travel from on-board vehicle input sensor data or off board input sensor data, generating a vehicle travel direction icon (e.g., arrow) that indicates the direction of vehicle travel, and overlaying the vehicle travel direction icon on the bird's eye view graphic (e.g., on the direction of travel graphic).

In one embodiment, the method further includes retrieving LIDAR data from on-board vehicle input sensor data, generating a LIDAR map graphic that indicates objects sensed via the LIDAR data, and overlaying the LIDAR map graphic on the bird's eye view graphic.

In one embodiment, the method further includes retrieving vehicle speed data that indicates current vehicle speed from on-board vehicle input sensor data, generating a vehicle speed graphic that indicates the current vehicle speed, and overlaying the vehicle speed graphic on the bird's eye view graphic.

In one embodiment, the method further includes generating a vehicle acceleration graphic that indicates whether the vehicle is accelerating, and overlaying the vehicle acceleration graphic on the bird's eye view graphic.

In one embodiment, the method further includes assessing whether vehicle travel into an area represented by an area of the direction of travel graphic could result in unsafe vehicle operation (e.g., driving off the road, collision with an obstacle), and applying a specific color to the area of the direction of travel graphic when vehicle travel into the area represented by the area of the direction of travel graphic could result in unsafe vehicle operation.

In one embodiment, the method further includes controlling a plurality of haptic actuators to provide haptic feedback to convey a sense of direction to an occupant seated in a seating apparatus while riding in the vehicle.

In one embodiment, the method further includes controlling a plurality of speakers in a directional speaker system in a vehicle to convey a sense of direction to an occupant seated in a seating apparatus while riding in the vehicle.

In another embodiment, a method for providing a situational awareness interface for an occupant of an automated vehicle is provided. The method includes: generating a vehicle route graphic that displays a street level map of an area that includes a current location of the vehicle and an intended destination of the vehicle along with a visual depiction of a planned route and one or more alternate routes for the vehicle from the current location of the vehicle to the intended destination; determining a probability of requiring assistance or interaction and an estimated time of arrival for each of the planned route and the one or more alternate routes; providing a visual indication of the probability of requiring assistance or interaction and the estimated time of arrival for each of the planned route and the one or more alternate routes on the vehicle route graphic; configuring the visual depiction of the planned route and the one or more alternate routes to be selectable, wherein when a route is selected, the vehicle is instructed to navigate in accordance with the selected route; and signaling a display device to display the situational awareness interface which includes the vehicle route graphic.

In one embodiment, the method includes determining a route from the current location of the vehicle to the intended destination that reduces a likelihood of needing operator intervention, and providing the route that reduces the likelihood of needing operator intervention as the planned route for the vehicle or the one or more alternate routes for the vehicle.

In another embodiment, a non-transitory computer readable media encoded with programming instructions configurable to cause a processor to perform a method for providing a situational awareness interface for an occupant of an automated vehicle is provided. The method includes: generating a bird's eye view graphic that provides an elevated view of a roadway surrounding the vehicle; overlaying a direction of travel graphic on the bird's eye view graphic centered at a location consistent with retrieved location data wherein the direction of travel graphic has a predetermined length and width centered around the location; positioning, based on the location data, a vehicle icon that is representative of the vehicle on the bird's eye view graphic overlaying the direction of travel graphic; retrieving potential obstacle location data for each potential obstacle identified within a predetermined distance surrounding the vehicle; positioning an obstacle icon representative of the potential obstacle on the bird's eye view graphic for each identified potential obstacle; generating a vehicle route graphic that displays a street level map of an area that includes a current location of the vehicle and an intended destination of the vehicle along with a visual depiction of a planned route and one or more alternate routes for the vehicle from the current location of the vehicle to the intended destination; determining a probability of requiring assistance or interaction and an estimated time of arrival for each of the planned route and the one or more alternate routes; providing a visual indication of the probability of requiring assistance or interaction and the estimated time of arrival for each of the planned route and the one or more alternate routes on the vehicle route graphic; configuring the visual depiction of the planned route and the one or more alternate routes to be selectable, wherein when a route is selected, the vehicle is instructed to navigate in accordance with the selected route; and signaling a display device to display the situational awareness interface which includes the bird's eye view graphic and the vehicle route graphic.

In another embodiment, a non-transitory computer readable media encoded with programming instructions configurable to cause a processor to perform a method for providing a situational awareness interface for an occupant of an automated vehicle is provided. The method includes: generating a bird's eye view graphic that provides an indication of vehicle maneuver intent; generating a vehicle route graphic that displays a street level map of an area that includes a current location of the vehicle and an intended destination of the vehicle along with a visual depiction of a planned route and one or more alternate routes for the vehicle from the current location of the vehicle to the intended destination; determining a probability of requiring assistance or interaction and an estimated time of arrival for each of the planned route and the one or more alternate routes; providing a visual indication of the probability of requiring assistance or interaction and the estimated time of arrival for each of the planned route and the one or more alternate routes on the vehicle route graphic; configuring the visual depiction of the planned route and the one or more alternate routes to be selectable, wherein when a route is selected, the vehicle is instructed to navigate in accordance with the selected route; and signaling a display device to display the situational awareness interface which includes the bird's eye view graphic and the vehicle route graphic.

In another embodiment, a non-transitory computer readable media encoded with programming instructions configurable to cause a processor to perform a method for providing a situational awareness interface for an occupant of an automated vehicle is provided. The method includes: generating a vehicle route graphic that displays a street level map of an area that includes a current location of the vehicle and an intended destination of the vehicle along with a visual depiction of a planned route and one or more alternate routes for the vehicle from the current location of the vehicle to the intended destination; determining a probability of requiring assistance or interaction and an estimated time of arrival for each of the planned route and the one or more alternate routes; providing a visual indication of the probability of requiring assistance or interaction and the estimated time of arrival for each of the planned route and the one or more alternate routes on the vehicle route graphic; configuring the visual depiction of the planned route and the one or more alternate routes to be selectable, wherein when a route is selected, the vehicle is instructed to navigate in accordance with the selected route; and signaling a display device to display the situational awareness interface which includes the vehicle route graphic.

### BRIEF DESCRIPTION OF THE DRAWINGS

The exemplary embodiments will hereinafter be described in conjunction with the following drawing figures, wherein like numerals denote like elements, and wherein:

FIG. 1 is a block diagram depicting an example system component architecture for providing route and risk assessment recommendations for autonomous land travel and for providing an occupant display for increasing the situational awareness of an occupant in a fully or semi-automated vehicle, in accordance with various embodiments;

FIG. 2 is a process flow diagram depicting an example process in an example system component architecture 100 for enabling a plurality of remote operators in an operator pool to simultaneously monitor and control a large number of AVs in a fleet of AVs and to enhance occupant awareness and provide a control interface for occupants in AVs, in accordance with various embodiments;

FIG. 3 is a diagram depicting an example situational awareness interface generated by a supervisory control system for use by an occupant in a vehicle, in accordance with various embodiments;

FIG. 4A is a diagram depicting example haptic actuators in an example seating apparatus in a vehicle, in accordance with various embodiments;

FIG. 4B is a diagram depicting example speakers in an example directional speaker system in a vehicle, in accordance with various embodiments;

FIG. 5 is a process flow chart depicting an example process for generating a bird's eye view graphic for a situational awareness interface, in accordance with various embodiments; and

FIG. 6 is a process flow chart depicting an example process for generating a vehicle route graphic for a situational awareness interface, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, LIDAR, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The subject matter described herein discloses apparatus, systems, techniques, and articles for providing an occupant in a fully or semi-automated vehicle with information to build trust in automation, understand and select routing options, identify risks, prepare for vehicle intent of maneuvers, and a means to procure assistance when necessary. The following disclosure describes apparatus, systems, techniques, and articles for providing an occupant in a fully or semi-automated vehicle with an occupant display that shows vehicle sensing of nearby objects and intent for upcoming maneuvers.

The following disclosure describes apparatus, systems, techniques, and articles for providing an occupant in a fully or semi-automated vehicle with an occupant display that helps prepare an occupant to allow the occupant to know that all vehicle systems are ready. The following disclosure describes apparatus, systems, techniques, and articles for providing an occupant display for increasing the situational awareness of an occupant in a fully or semi-automated vehicle. The occupant display can identify vehicle operation, highlight risks, and inform an occupant of vehicle intent. The following disclosure describes apparatus, systems, techniques, and articles for providing an occupant in a fully or semi-automated vehicle with alternative routes showing a probability of requiring assistance/interaction with an estimated time of arrival. The following disclosure describes apparatus, systems, techniques, and articles for providing an occupant in a fully or semi-automated vehicle with a way to choose/alter route in real-time. The following disclosure describes apparatus, systems, techniques, and articles for providing a display that prepares a occupant for upcoming remote operation. The following disclosure describes apparatus, systems, techniques, and articles for routing a vehicle to reduce the need for operator intervention. The following disclosure describes apparatus, systems, techniques, and articles for providing a display that informs an occupant that help is on the way.

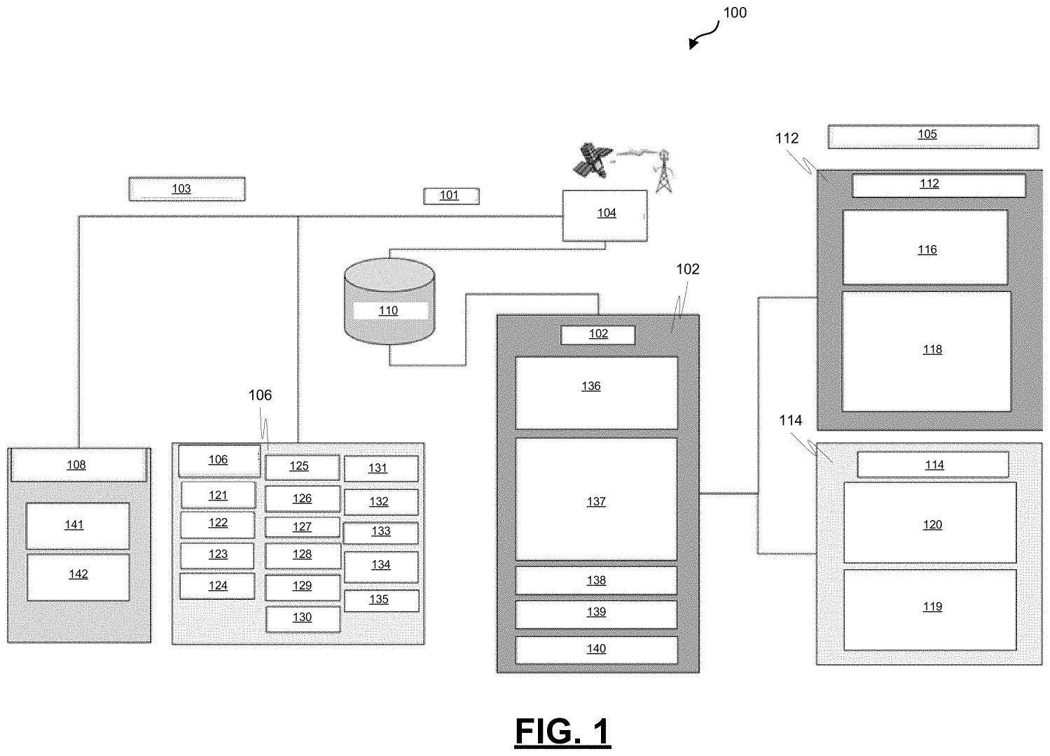

FIG. 1 is a block diagram depicting an example system component architecture 100 for providing route and risk assessment recommendations for autonomous land travel and for providing an occupant display for increasing the situational awareness of an occupant in a fully automated or semi-automated vehicle. An automated vehicle (AV), e.g., fully or semi-automated vehicle, may be a passenger car, truck, sport utility vehicle, recreational vehicle, or some other type of land vehicle. The example system component architecture 100 includes a processing entity 102 that is connected by a data and communication network 104 to a plurality of automated vehicles and infrastructure (e.g., using V2X communication 101) in an environment in which the plurality of automated vehicles operate to allow the processing entity 102 to form a relational network with the plurality of automated vehicles and infrastructure to obtain data from system inputs 103 including on-board vehicle input sources 106 associated with the plurality of automated vehicles and data from off-board input sources 108 associated with the infrastructure. As used herein the term “relational network” refers to any network in which the various constituents of the network work together to accomplish a purpose.

The on-board vehicle input sources 106 for the automated vehicle include one or more of sensing devices that sense observable conditions of the exterior environment and/or the interior environment of a vehicle and generate sensor data relating thereto. The one or more sensing devices in this example include Personal Devices/Cameras 121 (e.g., cameras or video recording devices on smartphones, tablet computers, phablets, etc.), Personal Devices/Sensors 122 (e.g., sensors, such as GPS, Lidar and other sensors, on smartphones, tablet computers, phablets, etc.), Vehicle/Interior Motion Sensors 123, external/internal mics 124, LIDAR/Radar 125, External Cameras 126, Internal Cameras 127, Brake Sensor 128, Steering sensor 129, Throttle Sensor 130, Vehicle Switches 131, HMI Interactions 132, GPS 133, 6 DOF (degree of freedom) Accelerometers 134, and/or vehicle speed sensing devices 135. The on-board vehicle input sources 106 are used to collect observable data that may be used to create data components necessary to assess mission risk.

The off-board input sources 108 include one or more of sensing devices that sense observable conditions in an environment through which the plurality of automated vehicles may travel and generate data relating thereto. The generated data may include infrastructure sensor data 141 (e.g., inductive-loop traffic detectors, intersection monitoring systems, floating car data, etc.) and infrastructure camera data 142. The off-board input sources 108 may be coupled to infrastructure such as traffic lights, traffic signs, bridges, buildings, and other infrastructure items.

The example system component architecture 100 also includes a data integration module 110 for accumulating and storing the data obtained over the data and communication network 104 from the on-board vehicle input sources 106 and the off-board input sources 108, operation center interfaces 112 for operation center personnel, and vehicle interfaces 114 for AVs. The data integration module 110 includes processing hardware, software, and storage media for storing the data obtained over the data and communication network 104. The operation center interfaces 112 include a supervisory control interface 116 and a teleoperation interface 118 for controlling an AV. The vehicle interfaces 114 include an occupant information display 120 for an occupant in an AV and a remote override interface 119 for controlling the behavior and/or trajectory of an AV. The supervisory control interface 116 allows for remote monitoring of the vehicle operational movement using a supervisory interface display and controls. The teleoperation interface 118 allows for remote vehicle control of the steering, throttle, and braking of the vehicle.

The processing entity 102 includes at least one controller comprising at least one processor and a computer-readable storage device or media encoded with programming instructions for configuring the controller. The processor may be any custom-made or commercially available processor, a central processing unit (CPU), a graphics processing unit (GPU), an application specific integrated circuit (ASIC), a field programmable gate array (FPGA), an auxiliary processor among several processors associated with the controller, a semiconductor-based microprocessor (in the form of a microchip or chip set), any combination thereof, or generally any device for executing instructions.

The computer readable storage device or media may include volatile and non-volatile storage in read-only memory (ROM), random-access memory (RAM), and keep-alive memory (KAM), for example. KAM is a persistent or non-volatile memory that may be used to store various operating variables while the processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable programming instructions, used by the controller. The programming instructions may include one or more separate programs, each of which comprises an ordered listing of executable instructions for implementing logical functions.

Via system outputs 105, the processing entity 102 is configured to enable a plurality of remote operators in an operator pool to simultaneously monitor and control a large number of AVs in a fleet of AVs via the operation center interfaces 112, which include the supervisory control interface 116 and the teleoperation interface 118. The example supervisory control interface 116 includes a display and controls. The example teleoperation interface 118 includes sensing, control inputs, steering, braking, and lag.

Via system outputs 105, the processing entity 102 is also configured to enhance occupant awareness in an AV and provide a control interface for an occupant in the AV via the vehicle interfaces 114, which include the occupant information display 120 and the remote override interface 119. The example occupant information display 120 provides a display of projected AV maneuvers and travel plan and a display of objects outside of the vehicle sensed by the vehicle. The example remote override interface 119 provides an occupant with a way to halt or change an AV behavior and/or trajectory.

The processing entity 102 is configured to: process traffic around an AV, generate a risk field around the AV, process a trajectory overlay, and determine a temporal urgency for operator intervention with the AV (operation 136). The processing entity 102 is configured to perform temporal risk prediction (operation 137). Temporal risk prediction may include considering: past, now, forecast risk prediction; mission type prior; vehicle type prior; location-time prior; behavior prior; traffic, weather; relative progress update; and bother risk. The processing entity 102 is configured to perform load balancing (operation 138) regarding assignment of AVs to operators in an operator pool. The processing entity 102 is configured to execute a handoff algorithm (operation 139) to determine when and to whom to handoff AV control to. The processing entity 102 is configured to execute a teleoperation algorithm (operation 140) to facilitate operator control of an AV. The teleoperation algorithm includes a process summary of commands to dynamically control the vehicle trajectory.

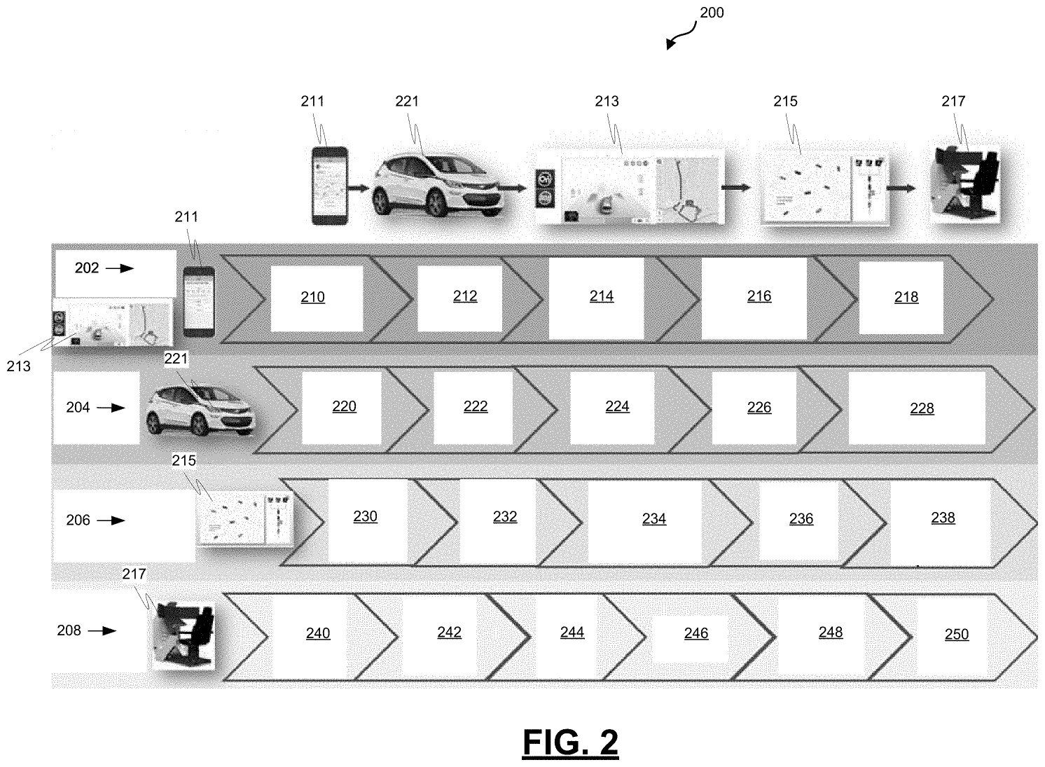

FIG. 2 is a process flow diagram depicting an example process 200 in an example system component architecture 100 for enabling a plurality of remote operators in an operator pool to simultaneously monitor and control a large number of AVs in a fleet of AVs and to enhance occupant awareness and provide a control interface for occupants in AVs. The example process includes a plurality of asynchronously executing subprocesses including an example occupant experience process 202 for occupants utilizing an AV in the fleet of AVs, an example vehicle decision cycle 204 for each AV in the fleet of AVs, an example supervisory control decision cycle 206 in the example supervisory control system, and an example operator process 208 for remote operators in the operator pool.

The example occupant experience process 202 includes a user (e.g., occupant) of an AV service such as an AV taxi service requesting a ride to a destination (operation 210). The request for a ride may be made through a user device 211 such as a tablet computer, a smartphone, phablet, laptop computer, notebook computer, or some other electronic device with user access. The request for a ride may be made to a central scheduling system for the fleet of AVs via a supervisory control system (e.g., the processing entity 102).

The example occupant experience process 202 includes user acceptance of an assigned route (operation 212) that is responsive to the request for a ride. The user acceptance may be made through the user device 211.

The example occupant experience process 202 includes observing a situational awareness interface 213 (operation 214). The example situational awareness interface 213 is generated by a supervisory control system (e.g., the processing entity 102) and provides the occupant in an AV with information to build trust in automation, understand and select routing options, identify risks, prepare for vehicle intent of maneuvers, and a way to procure assistance when necessary. The situational awareness interface 213 may be provided for display on the user device 211 and/or a display device situated within the AV.

The example occupant experience process 202 includes an occupant requesting intervention (operation 216). A request for intervention may be made when an occupant detects the need for or has a specific desire for assistance from a remote operator for completing a ride.

The example occupant experience process 202 includes observing and confirming the outcome of the ride (operation 218). The occupant may confirm the outcome of the ride using the user device 211.

The example vehicle decision cycle 204 includes observing situation and need (operation 220). The example vehicle decision cycle 204 is performed by a processing component or controller in an AV 221 that has been dispatched (e.g., by the central scheduling system) to service the request for a ride.

The example vehicle decision cycle 204 includes publishing risk level (operation 222). The risk level for the AV 221 is determined by the AV 221 and published to the supervisory control system (e.g., the processing entity 102). The risk level captures and conveys the probability of mission failure (one minus the probability of mission success) which incorporates the likelihood of delays, the likelihood of needing assistance due to the complexities of the driving environment in the places to be traversed, due to the traffic congestion, due to the vehicle health and vehicle capabilities, plus the severity of the failure. The expected recovery time (or likelihood) from failure is also incorporated.

The example vehicle decision cycle 204 includes reassessing situation (operation 224) and updating risk level (operation 226) based on reassessment. The AV 221 continuously reassesses its situation during a trip.

The example vehicle decision cycle 204 further includes requesting operator interaction when imperative (operation 228). When through the reassessing its situation and updating its risk level the AV 221 determines that it needs operator intervention to complete a trip, the AV 221 requests operator interaction from the supervisory control system (e.g., the processing entity 102).

The example supervisory control decision cycle 206 is performed by a supervisory control system (e.g., the processing entity 102) and includes dispatching a ride request to the vehicle (e.g., AV 221) (operation 230). The ride request is dispatched responsive to a request for a ride.

The example supervisory control decision cycle 206 includes observing progress and risk level for the trip (operation 232) and analyzing interaction need characteristics (operation 234). The result from the observing and analyzing can result in the generation of an operator situational awareness interface 215 that provides a user interface that enables a plurality of remote operators to simultaneously monitor and control a greater number of automated vehicles.

The example supervisory control decision cycle 206 includes tracking operator loads (operation 236) and handing off vehicle assistance tasks to appropriate available operator (operation 238) when operator intervention is necessary.

The example operator process 208 includes accepting, by a remote operator, a task through an operator interface 217 (operation 240). The operator interface 217 includes a plurality of display devices for displaying the operator situational awareness interface 215 and for use by the operator when exercising control over an AV 221.

The example operator process 208 includes observing situation and need (operation 242). The operator may perform the observing by observing the operator situational awareness interface 215 on the operator interface 217. The example operator process 208 further includes the operator deciding a course of action (operation 244), executing the course of action (operation 246), observing and confirming the outcome (operation 248), and releasing control (operation 250) of an AV 221 after completing vehicle assistance.

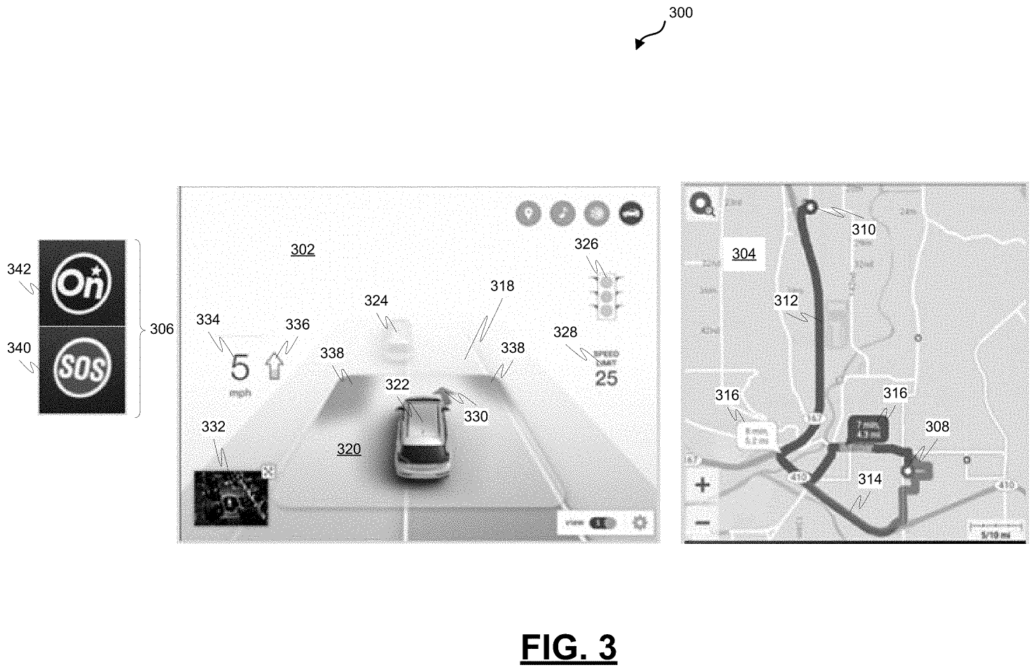

FIG. 3 is a diagram depicting an example situational awareness interface 300 generated by a supervisory control system (e.g., the processing entity 102, other cloud-based location, or in the vehicle) for use by an occupant in a vehicle. The example situational awareness interface 300 includes a bird's eye view map graphic 302 that provides an elevated view of an area directly behind, around, and in front of the vehicle. The example situational awareness interface 300 also includes a vehicle route graphic 304 that displays a street level map of the area around the vehicle and the vehicle's intended destination along with a planned route and one or more alternate routes for the vehicle to traverse to get from its current location to the vehicle's intended destination. The example situational awareness interface 300 further includes an occupant control interface 306 that allows the occupant to stop the vehicle and/or summon help, and that provides communications, in-vehicle security, emergency services, hands-free calling, turn-by-turn navigation, and remote diagnostics for the vehicle. The situational awareness interface 300 may be provided for display on a mobile display device such as a mobile user device (e.g., smartphone, tablet computer, phablet, touchscreen device, etc.) and/or a fixed display device situated within the vehicle.

To generate the example situational awareness interface 300, the example supervisory control system is configured to generate the vehicle route graphic 304 that displays a street level map of an area that includes a current location 308 of the vehicle and an intended destination 310 of the vehicle along with a visual depiction of a planned route 312 for the vehicle and one or more alternate routes 314 for the vehicle to traverse to get from the current location 308 to the intended destination 310. The example supervisory control system is further configured to determine a probability of requiring assistance or interaction and an estimated time of arrival for each of the planned route and the one or more alternate routes, and provide a visual indication 316 of the probability of requiring assistance or interaction and the estimated time of arrival for each of the planned route and the one or more alternate routes on the vehicle route graphic 304. The supervisory control system is further configured to determine a route from the current location 308 of the vehicle to the intended destination 310 that reduces the likelihood of needing operator intervention, and provide the route that reduces the likelihood of needing operator intervention as the planned route 312 for the vehicle or the one or more alternate routes 314 for the vehicle. The example supervisory control system is further configured to configure the visual depiction of the planned route 312 and the one or more alternate routes 314 to be selectable, wherein when a route is selected, the example supervisory control system instructs the vehicle to navigate in accordance with the selected route. The example supervisory control system is further configured to signal the display device to display the situational awareness interface 300 which includes the vehicle route graphic 304.

To generate the example situational awareness interface 300, the example supervisory control system is further configured to: retrieve location data for the vehicle (e.g., from the data integration module 110); generate the bird's eye view graphic 302 that provides an elevated view of a roadway 318 directly behind, around, and in front of the vehicle; and overlay a direction of travel graphic 320 on the bird's eye view graphic 302 centered at a location consistent with the location data wherein the direction of travel graphic 320 has a predetermined length and width centered around the location. The example supervisory control system is further configured to position a vehicle icon 322 that is representative of the vehicle on the bird's eye view graphic 302 overlaying the direction of travel graphic 320 and positioned based on the location data; retrieve potential obstacle location data for each potential obstacle identified within a predetermined distance surrounding the vehicle based on on-board vehicle input sensor data or off board input sensor data; and, for each identified potential obstacle, position an obstacle icon 324 representative of the potential obstacle on the bird's eye view graphic 302 wherein the obstacle icon 324 is positioned based on the retrieved potential obstacle location data. The example supervisory control system is further configured to signal the display device to display the bird's eye view graphic 302 with the direction of travel graphic 320, the vehicle icon 322, and any positioned obstacle icon 324 overlayed thereon as part of the situational awareness interface 300.

To generate the example bird's eye view graphic 302, the example supervisory control system is further configured to identify a state of an upcoming traffic control device (e.g., traffic light, stop sign, yield sign) in a direction of vehicle travel from on-board vehicle input sensor data or off board input sensor data, generate a traffic control device icon 326 representative of the upcoming traffic control device that indicates the state of the upcoming traffic control device, and overlay the traffic control device icon 326 on the bird's eye view graphic 302.

To generate the example bird's eye view graphic 302, the example supervisory control system is further configured to identify a speed limit in a direction of vehicle travel from on-board vehicle input sensor data or off board input sensor data, generate a speed limit icon 328 that indicates the speed limit in the direction of vehicle travel, and overlay the speed limit icon 328on the bird's eye view graphic 302.

To generate the example bird's eye view graphic 302, the example supervisory control system is further configured to identify a direction of vehicle travel from on-board vehicle input sensor data or off board input sensor data, generate a vehicle travel direction icon 330 (e.g., arrow) that indicates the direction of vehicle travel, and overlay the vehicle travel direction icon 330 on the bird's eye view graphic 302 (e.g., on the direction of travel graphic).

To generate the example bird's eye view graphic 302, the example supervisory control system is further configured to retrieve LIDAR data from on-board vehicle input sensor data, generate a LIDAR map graphic 332 that indicates objects sensed via the LIDAR data, and overlay the LIDAR map graphic 332 on the bird's eye view graphic 302.

To generate the example bird's eye view graphic 302, the example supervisory control system is further configured to retrieve vehicle speed data that indicates current vehicle speed from on-board vehicle input sensor data, generate a vehicle speed graphic 334 that indicates the current vehicle speed, and overlay the vehicle speed graphic 334 on the bird's eye view graphic.

To generate the example bird's eye view graphic 302, the example supervisory control system is further configured to generate a vehicle acceleration graphic 336 that indicates whether the vehicle is accelerating, and overlay the vehicle acceleration graphic 336 on the bird's eye view graphic 302.

To generate the example bird's eye view graphic 302, the example supervisory control system is further configured to assess whether vehicle travel into an area represented by an area of the direction of travel graphic could result in unsafe vehicle operation (driving off the road, collision with an obstacle), and apply a specific color 338 to the area of the direction of travel graphic 320 when vehicle travel into the area represented by the area of the direction of travel graphic 320 could result in unsafe vehicle operation.

The example supervisory control system is further configured to generate an occupant control interface 306 to include in the situational awareness interface 300. To accomplish this, the example supervisory control system is configured to generate an occupant control interface 306 that includes an assistance interface 340 (e.g., SOS button) for enabling the occupant to stop the vehicle or summon help, and provide the occupant control interface 306 in the situational awareness interface 300. The example supervisory control system is further configured to provide an in-vehicle security and emergency services system (e.g., OnStar) interface 342 in the occupant control interface 306 for enabling the occupant to access a remote operator for an in-vehicle security and emergency services system. The example supervisory control system is further configured to signal the display device to display an informational graphic (not shown) informing that a remote operator will take control of the vehicle as part of the situational awareness interface 300.

The example supervisory control system is further configured to generate a ready-state graphic (not shown) to include in the situational awareness interface 300. To accomplish this the example supervisory control system is configured to identify a readiness state for a plurality of vehicle systems for autonomous travel, generate a ready-state graphic that provides a visual indication of the readiness state for the plurality of vehicle systems, and signal the display device to display the ready-state graphic as part of the situational awareness interface.

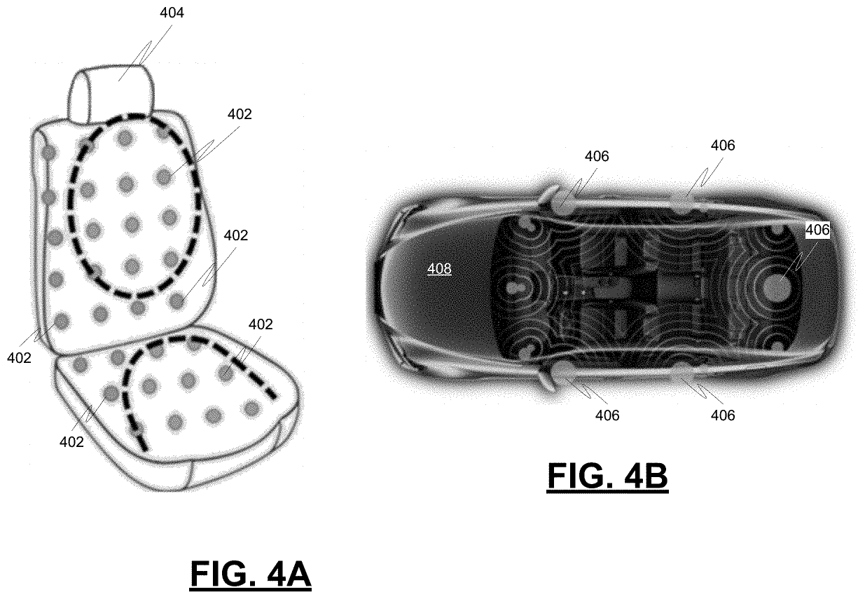

FIG. 4A is a diagram depicting example haptic actuators 402 in an example seating apparatus 404 in a vehicle. The haptic actuators 402 can be controlled to provide haptic feedback to convey a sense of direction to an occupant seated in the seating apparatus 404 while riding in the AV. The use of haptic actuators can be made part of the occupant situation awareness interface.

FIG. 4B is a diagram depicting example speakers 406 in an example directional speaker system in a vehicle 408. The example directional speaker system can be used to convey a sense of direction to an occupant seated in the seating apparatus 404 while riding in the AV. The use of the directional speaker system can be made part of the occupant situation awareness interface.

Using the example bird's eye view graphic 302, the directional speaker system, and the haptic actuators 402, the example supervisory control system can provide information regarding an upcoming maneuver. For example, the example supervisory control system may determine that a stoplight is ahead, and the example bird's eye view graphic 302 may show a notification (e.g., traffic control device icon 326) so that an occupant is aware that the vehicle will decelerate soon. Additionally, the example supervisory control system may provide an audio notification of the upcoming maneuver through the speakers 406 of the vehicle and or the haptic actuators 402. In this way, an occupant may receive foreknowledge of upcoming maneuvers by the vehicle, and is not surprised by an unanticipated deceleration. This can increase the overall satisfaction and trust of an occupant in the operation of an automated vehicle.

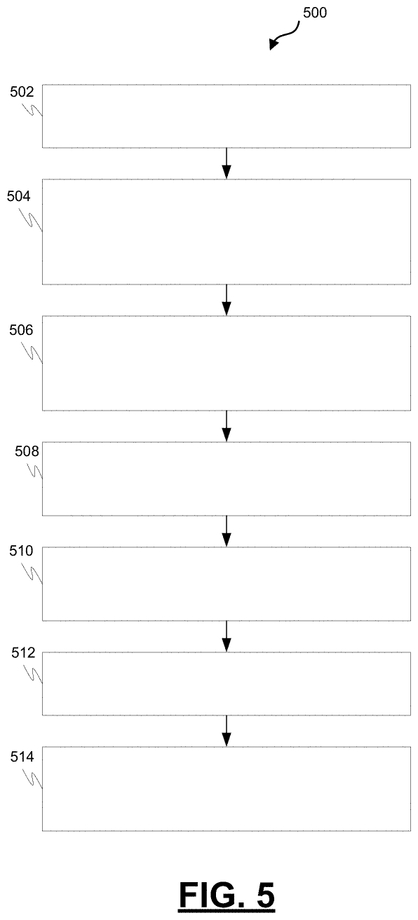

FIG. 5 is a process flow chart depicting an example process 500 for generating a bird's eye view graphic for a situational awareness interface in an AV. The order of operation within process 500 is not limited to the sequential execution as illustrated in the FIG. 5 but may be performed in one or more varying orders as applicable and in accordance with the present disclosure.

The example process 500 includes retrieving location data for a vehicle (operation 502), and generating a bird's eye view graphic that provides an elevated view of a roadway directly behind, around, and in front of the vehicle (operation 504). The example process 500 includes overlaying a direction of travel graphic on the bird's eye view graphic centered at a location consistent with the location data (operation 506), and positioning a vehicle icon that is representative of the vehicle on the bird's eye view graphic overlaying the direction of travel graphic and positioned based on the location data (operation 508).

The example process 500 includes retrieving potential obstacle location data for each potential obstacle identified within a predetermined distance surrounding the vehicle (operation 510). For each identified potential obstacle, the example process 500 includes positioning an obstacle icon representative of the potential obstacle on the bird's eye view graphic wherein the obstacle icon is positioned based on the retrieved potential obstacle location data (operation 512). The example process 500 includes signaling a display device to display the bird's eye view graphic with the direction of travel graphic, the vehicle icon, and any positioned obstacle icon overlayed thereon (operation 514).

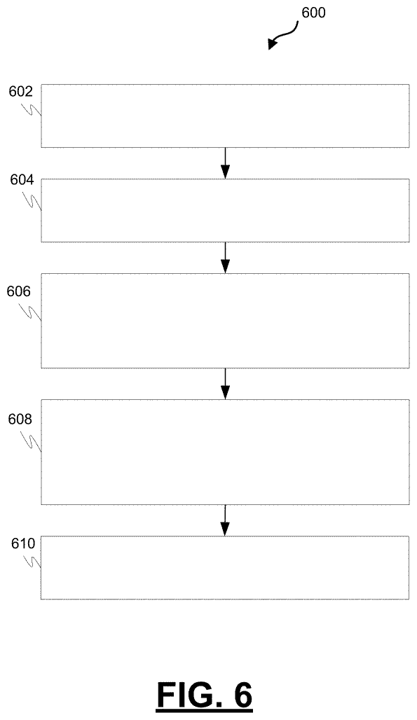

FIG. 6 is a process flow chart depicting an example process 600 for generating a vehicle route graphic for a situational awareness interface in an AV. The order of operation within process 600 is not limited to the sequential execution as illustrated in the FIG. 6 but may be performed in one or more varying orders as applicable and in accordance with the present disclosure.

The example process 600 includes generating a vehicle route graphic that displays a street level map of an area that includes a current location of the vehicle and an intended destination of the vehicle (operation 602). The vehicle route graphic may also provide a visual depiction of a planned route for the vehicle and one or more alternate routes for the vehicle to traverse to get from the current location to the intended destination.

The example process 600 includes determining a probability of requiring assistance or interaction and an estimated time of arrival for each of the planned route and the one or more alternate routes (operation 604) and providing a visual indication of the probability of requiring assistance or interaction and the estimated time of arrival for each of the planned route and the one or more alternate routes on the vehicle route graphic (operation 606). This may involve determining a route from the current position of the vehicle to the intended destination that reduces the likelihood of needing operator intervention, and providing the route that reduces the likelihood of needing operator intervention as the planned route for the vehicle or the one or more alternate routes for the vehicle.

The example process 600 includes configuring the visual depiction of the planned route and the one or more alternate routes to be selectable (operation 608). When a route is selected, the vehicle is instructed to navigate in accordance with the selected route. The example process 600 further includes signaling a display device to display the situational awareness interface which includes the vehicle route graphic (operation 610).

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A supervisory control system for providing a situational awareness interface for an occupant of an automated vehicle, the system comprising a controller configured to:
generate a bird's eye view graphic that provides an indication of vehicle maneuver intent;
generate a vehicle route graphic that displays a street level map of an area that includes a current location of the vehicle and an intended destination of the vehicle along with a visual depiction of a planned route and one or more alternate routes for the vehicle from the current location of the vehicle to the intended destination;
determine a probability of requiring assistance or interaction and an estimated time of arrival for each of the planned route and the one or more alternate routes;
provide a visual indication of the probability of requiring assistance or interaction and the estimated time of arrival for each of the planned route and the one or more alternate routes on the vehicle route graphic;
configure the visual depiction of the planned route and the one or more alternate routes to be selectable, wherein when a route is selected, the controller instructs the vehicle to navigate in accordance with the selected route; and
signal a display device to display the situational awareness interface which includes the bird's eye view graphic and the vehicle route graphic.

2. The supervisory control system of claim 1, wherein the controller is further configured to:
identify a readiness state for a plurality of vehicle systems for autonomous travel;
generate a ready-state graphic that provides a visual indication of the readiness state for the plurality of vehicle systems; and
signal the display device to display the ready-state graphic as part of the situational awareness interface.

3. The supervisory control system of claim 1, wherein the controller is further configured to:
generate an occupant control interface that includes an assistance interface for enabling the occupant to stop the vehicle or summon help; and
provide the occupant control interface in the situational awareness interface.

4. The supervisory control system of claim 3, wherein the controller is further configured to:
provide an in-vehicle security and emergency services system interface in the occupant control interface for enabling the occupant to access a remote operator for an in-vehicle security and emergency services system.

5. The supervisory control system of claim 1, wherein the controller is further configured to signal the display device to display an informational graphic informing that a remote operator will take control of the vehicle as part of the situational awareness interface.

6. The supervisory control system of claim 1, wherein the controller is further configured to:
determine a route from the current location of the vehicle to the intended destination that reduces a likelihood of needing operator intervention; and
provide the route that reduces the likelihood of needing operator intervention as the planned route for the vehicle or the one or more alternate routes for the vehicle.

7. The supervisory control system of claim 1, wherein the controller is further configured to:
identify a state of an upcoming traffic control device in a direction of vehicle travel from on-board vehicle input sensor data or off board input sensor data;
generate a traffic control device icon representative of the upcoming traffic control device that indicates the state of the upcoming traffic control device; and
overlay the traffic control device icon on the bird's eye view graphic.

8. The supervisory control system of claim 1, wherein the controller is further configured to:
identify a speed limit in a direction of vehicle travel from on-board vehicle input sensor data or off board input sensor data;
generate a speed limit icon that indicates the speed limit in the direction of vehicle travel; and
overlay the speed limit icon on the bird's eye view graphic.

9. The supervisory control system of claim 1, wherein the controller is further configured to:
identify a direction of vehicle travel from on-board vehicle input sensor data or off board input sensor data;
generate a vehicle travel direction icon that indicates the direction of vehicle travel; and
overlay the vehicle travel direction icon on the bird's eye view graphic.

10. The supervisory control system of claim 1, wherein the controller is further configured to:
retrieve LIDAR data from on-board vehicle input sensor data;
generate a LIDAR map graphic that indicates objects sensed via the LIDAR data; and
overlay the LIDAR map graphic on the bird's eye view graphic.

11. The supervisory control system of claim 1, wherein the controller is further configured to:
retrieve vehicle speed data that indicates current vehicle speed from on-board vehicle input sensor data;
generate a vehicle speed graphic that indicates the current vehicle speed; and
overlay the vehicle speed graphic on the bird's eye view graphic.

12. The supervisory control system of claim 7, wherein the controller is further configured to:
generate a vehicle acceleration graphic that indicates whether the vehicle is accelerating; and
overlay the vehicle acceleration graphic on the bird's eye view graphic.

13. The supervisory control system of claim 1, wherein to generate a bird's eye view graphic that provides an indication of vehicle maneuver intent, the controller is configured to:
generate a bird's eye view graphic that provides an elevated view of a roadway surrounding the vehicle;
overlay a direction of travel graphic on the bird's eye view graphic centered at a location consistent with retrieved location data wherein the direction of travel graphic has a predetermined length and width centered around the location;
position, based on the location data, a vehicle icon that is representative of the vehicle on the bird's eye view graphic overlaying the direction of travel graphic;
retrieve potential obstacle location data for each potential obstacle identified within a predetermined distance surrounding the vehicle; and
for each identified potential obstacle, position an obstacle icon representative of the potential obstacle on the bird's eye view graphic.

14. The supervisory control system of claim 13, wherein the controller is further configured to:
assess whether vehicle travel into an area represented by an area of the direction of travel graphic could result in unsafe vehicle operation; and
apply a specific color to the area of the direction of travel graphic when vehicle travel into the area represented by the area of the direction of travel graphic could result in unsafe vehicle operation.

15. The supervisory control system of claim 1, wherein the controller is further configured to control a plurality of haptic actuators to provide haptic feedback to convey a sense of direction to an occupant seated in a seating apparatus while riding in the vehicle.

16. The supervisory control system of claim 1, wherein the controller is further configured to control a plurality of speakers in a directional speaker system in a vehicle to convey a sense of direction to an occupant seated in a seating apparatus while riding in the vehicle.

17. A supervisory control system for providing a situational awareness interface for an occupant of an automated vehicle, the system comprising a controller configured to:
generate a vehicle route graphic that displays a street level map of an area that includes a current location of the vehicle and an intended destination of the vehicle along with a visual depiction of a planned route and one or more alternate routes for the vehicle from the current location of the vehicle to the intended destination;
determine a probability of requiring assistance or interaction and an estimated time of arrival for each of the planned route and the one or more alternate routes;
provide a visual indication of the probability of requiring assistance or interaction and the estimated time of arrival for each of the planned route and the one or more alternate routes on the vehicle route graphic;
configure the visual depiction of the planned route and the one or more alternate routes to be selectable, wherein when a route is selected, the controller instructs the vehicle to navigate in accordance with the selected route; and
signal a display device to display the situational awareness interface which includes the vehicle route graphic.

18. A method for providing a situational awareness interface for an occupant of an automated vehicle, the method comprising:
generating a bird's eye view graphic that provides an indication of vehicle maneuver intent; generating a vehicle route graphic that displays a street level map of an area that includes a current location of the vehicle and an intended destination of the vehicle along with a visual depiction of a planned route and one or more alternate routes for the vehicle from the current location of the vehicle to the intended destination;
determining a probability of requiring assistance or interaction and an estimated time of arrival for each of the planned route and the one or more alternate routes;
providing a visual indication of the probability of requiring assistance or interaction and the estimated time of arrival for each of the planned route and the one or more alternate routes on the vehicle route graphic;
configuring the visual depiction of the planned route and the one or more alternate routes to be selectable, wherein when a route is selected, the vehicle is instructed to navigate in accordance with the selected route; and
signaling a display device to display the situational awareness interface which includes the bird's eye view graphic and the vehicle route graphic.

19. The method of claim 18, further comprising:
identifying a readiness state for a plurality of vehicle systems for autonomous travel;
generating a ready-state graphic that provides a visual indication of the readiness state for the plurality of vehicle systems; and
signaling the display device to display the ready-state graphic as part of the situational awareness interface.

20. The method of claim 18, further comprising:
determining a route from the current location of the vehicle to the intended destination that reduces a likelihood of needing operator intervention; and
providing the route that reduces the likelihood of needing operator intervention as the planned route for the vehicle or the one or more alternate routes for the vehicle.
